(19) United States
(12) Patent Application Publication
(10) Pub. No.: US 2018/0158390 A1
(43) Pub. Date: Jun. 7, 2018

(54) DIGITAL IMAGE MODIFICATION

(71) Applicant: Charles Sanglimsuwan, Bellevue, WA (US)

(72) Inventor: Charles Sanglimsuwan, Bellevue, WA (US)

(21) Appl. No.: 15/366,909

(22) Filed: Dec. 1, 2016

(51) Int. Cl. G09G 3/20; G06F 3/01

(52) U.S. Cl. CPC G09G 3/2003; G09G 2320/0686; G09G 2354/00; G06F 3/013

(57) ABSTRACT

A method for presenting digital images includes performing a retinal scan of an eye. Based on the retinal scan, a photoreceptor map indicating a distribution of photoreceptors in the eye is generated. A digital image including a plurality of image pixels is received, and an image pixel of the plurality is associated with one or more photoreceptors in the eye based on the photoreceptor map. The image pixel is modified to produce a retinal-corrected digital image based on a light sensitivity of the one or more photoreceptors associated with the image pixel. The retinal-corrected digital image is presented to the user via a near-eye display.

### BACKGROUND

The human eye includes a layer of tissue called the retina that converts visible light into nerve impulses in the brain. The retina includes a plurality of photoreceptor cells that occur in two general types: rod photoreceptor cells that provide black-and-white vision in low-light environments, and cone photoreceptor cells that provide color vision in relatively bright environments.

Head mounted display devices (HMDs) can be used to provide augmented reality (AR) experiences and/or virtual reality (VR) experiences by presenting digital imagery to a user. Digital imagery may take the form of a series of sequentially presented digital images that are shown to the user via a near-eye display. Such devices may also be used to present videos and/or slideshows as a series of digital images, as well as present static digital images such as pictures, diagrams, schematics, etc.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A method for presenting digital images includes performing a retinal scan of an eye. Based on the retinal scan, a photoreceptor map indicating a distribution of photoreceptors in the eye is generated. A digital image including a plurality of image pixels is received, and an image pixel of the plurality is associated with one or more photoreceptors in the eye based on the photoreceptor map. The image pixel is modified to produce a retinal-corrected digital image based on a light sensitivity of the one or more photoreceptors associated with the image pixel. The retinal-corrected digital image is presented to the user via a near-eye display.

### BRIEF DESCRIPTION OF THE DRAWINGS

FIG. 1 schematically shows an example environment including digital imagery only visible to a user via a head mounted display.

FIG. 2 schematically shows a digital image having a plurality of image pixels being presented on a display having a plurality of display pixels.

FIGS. 3A and 3B schematically show anatomical features of a human eye.

FIG. 4 illustrates an example method for presenting digital images.

FIG. 5 schematically shows generation of a photoreceptor map based on a retinal scan of an eye.

FIG. 6 schematically shows association of an image pixel with one or more photoreceptors based on a photoreceptor map.

FIG. 7 schematically shows updating of a photoreceptor map based on a current gaze vector of an eye.

FIG. 8 schematically shows modification of an image pixel of a digital image.

FIGS. 9A and 9B schematically illustrate presentation of digital imagery to a user of a virtual reality computing device.

FIG. 10 schematically shows an example virtual reality computing device.

FIG. 11 schematically shows an example computing system.

### DETAILED DESCRIPTION

A virtual or augmented reality computing device may present digital images to a user via a near-eye display. A digital image has a plurality of image pixels that are typically arranged in rows and columns. The number of rows and columns, and the resulting number of pixels, defines the resolution of the digital image. Depending on a resolution of a display device used to display the digital image, one or more image pixels map to one or more display pixels. Light associated with image pixels is emitted from corresponding display pixels and ultimately reaches one or more photoreceptors in the retina of the user's eye. The photoreceptors convert the incoming light into neural activity in the user's brain, allowing the user to see the presented digital image.

However, different photoreceptors in the user's retina have different light and color sensitivities, which can affect how incoming light is perceived by the user. For example, rod photoreceptors are more sensitive to light than cone photoreceptors, though cannot distinguish between different wavelengths of light. Cone photoreceptors are less sensitive to light, and occur in different varieties that respond to different wavelengths of light, thereby enabling color vision. The different types of photoreceptors are not uniformly distributed throughout the retina, meaning that light corresponding to a particular image pixel may activate photoreceptors having different light and/or color sensitivities from photoreceptors activated by light from a different image pixel. This can cause a presented digital image to appear, from the user's perspective, to have inconsistent color hues, tones, or saturation. While this same phenomenon exists when viewing real world objects, the effects of non-uniform photoreceptor distribution are believed to be amplified and less tolerable when viewing displayed imagery from a near-eye display.

Accordingly, the present disclosure is directed to an approach for modifying a digital image based on a photoreceptor distribution in a user's retina. A retinal scan of a user's eye is used to generate a photoreceptor map. Based on the photoreceptor map, an image pixel of a digital image is associated with one or more photoreceptors in the retina. This image pixel is then modified based on a light and/or color sensitivity of its associated photoreceptors to produce a retinal-corrected digital image, which is then presented via the near-eye display. This can be done for any number of image pixels in the digital image, and digital image modification can be done according to photoreceptor distributions of each of the user's eyes. Modifying digital imagery in this manner can help mitigate near-eye display issues perceived by a user due to the non-uniform distribution of photoreceptors in the user's retinas.

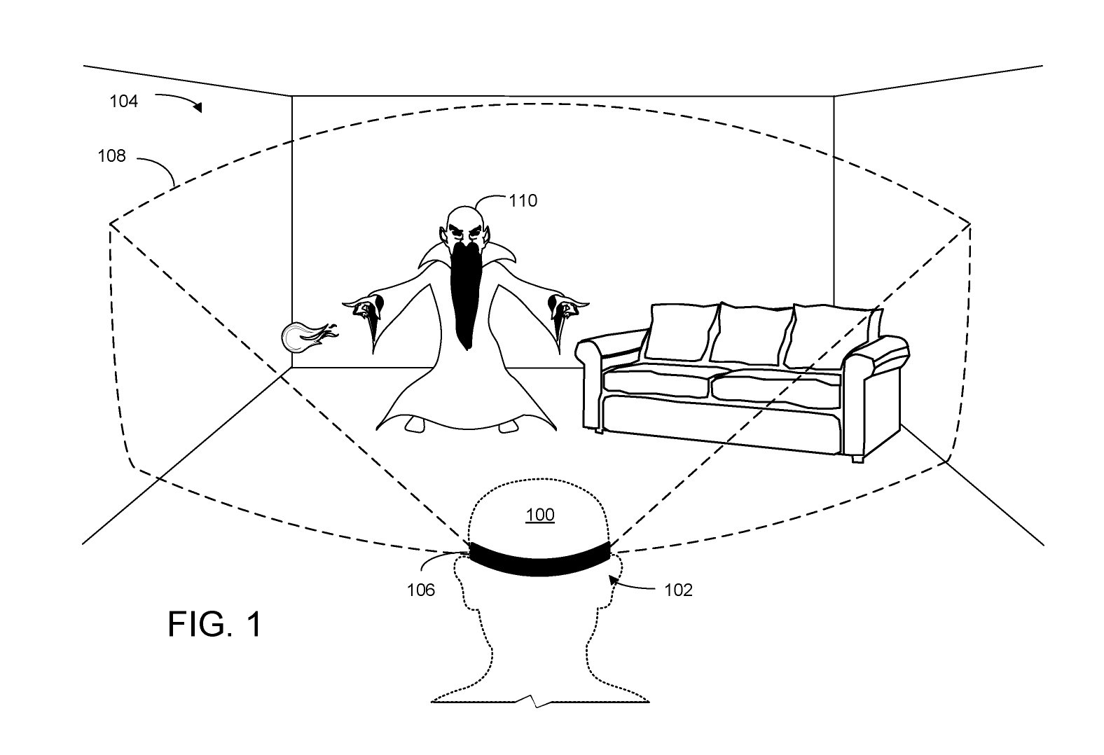

FIG. 1A schematically shows a user 100 wearing a virtual reality computing device 102 and viewing a surrounding environment 104. Virtual reality computing device 102 includes one or more near-eye displays 106 configured to present digital images to eyes of the user, as will be described below. FIG. 1A also shows a field of view (FOV) 108 of the user, indicating the area of environment 104 visible to user 100 from the illustrated vantage point.

Virtual reality computing device 102 may be used to view and interact with a variety of virtual objects and/or other virtual imagery. Such virtual imagery may be presented as a series of digital image frames presented via the near-eye display that dynamically update as the virtual imagery moves and/or a six degree-of-freedom (6-DOF) pose of the virtual reality computing device changes. Accordingly, though the present disclosure primarily focuses on modifying a single digital image, the digital image modification techniques described herein may be applied to each of a series of digital frames.

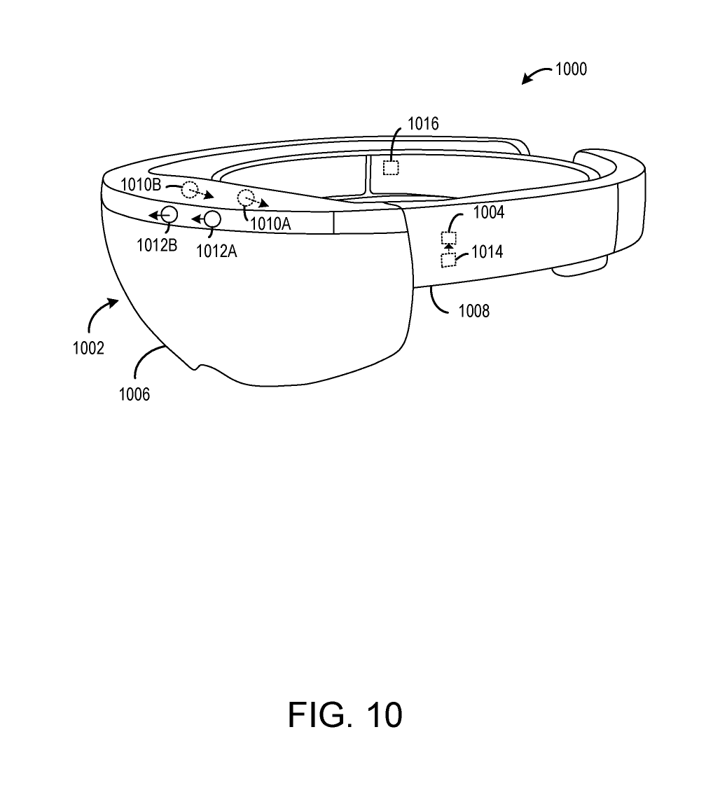

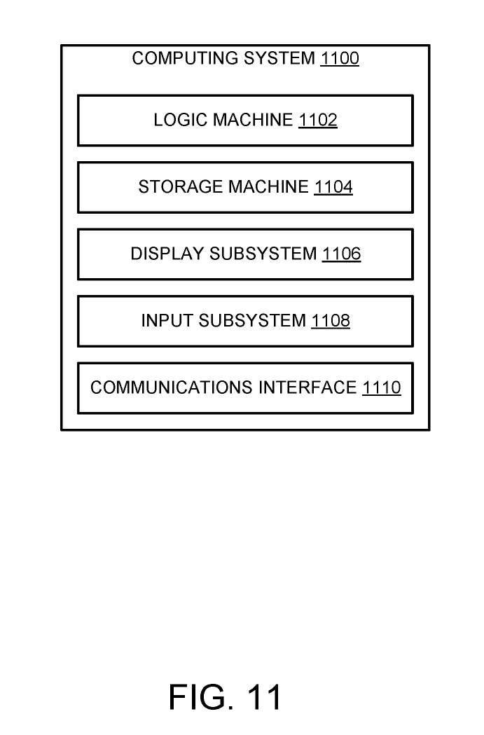

Though the term “virtual reality computing device” is generally used herein to describe a head mounted display device (HMD) including one or more near-eye displays, devices having other form factors may instead be used to view and manipulate digital imagery. For example, digital imagery may be presented and manipulated via a smartphone or tablet computer facilitating an augmented reality experience, and/or other suitable computing devices may instead be used. Virtual reality computing device 102 may be implemented as the virtual reality computing system 1000 shown in FIG. 10, and/or the computing system 1100 shown in FIG. 11.

Virtual reality computing device 102 may be an augmented reality computing device that allows user 100 to directly view a real world environment through a partially transparent near-eye display, or virtual reality computing device 102 may be fully opaque and either present imagery of a real world environment as captured by a front-facing camera, or present a fully virtual surrounding environment. To avoid repetition, experiences provided by both implementations are referred to as “virtual reality” and the computing devices used to provide the augmented or purely virtualized experiences are referred to as virtual reality computing devices. Further, it will be appreciated that regardless of whether a virtual or augmented reality experience is implemented, FIG. 1 shows at least some virtual imagery that is only visible to a user of a virtual reality computing device.

Specifically, FIG. 1 shows a virtual wizard 110 that is being presented to the user as part of an augmented reality environment, in which real objects in the user's surroundings are visible along with virtual imagery rendered by the virtual reality computing device. As described above, virtual wizard 110 may be presented to the user as a series of digital image frames having a plurality of image pixels, each of which is shown at a different display pixel of the near-eye display.

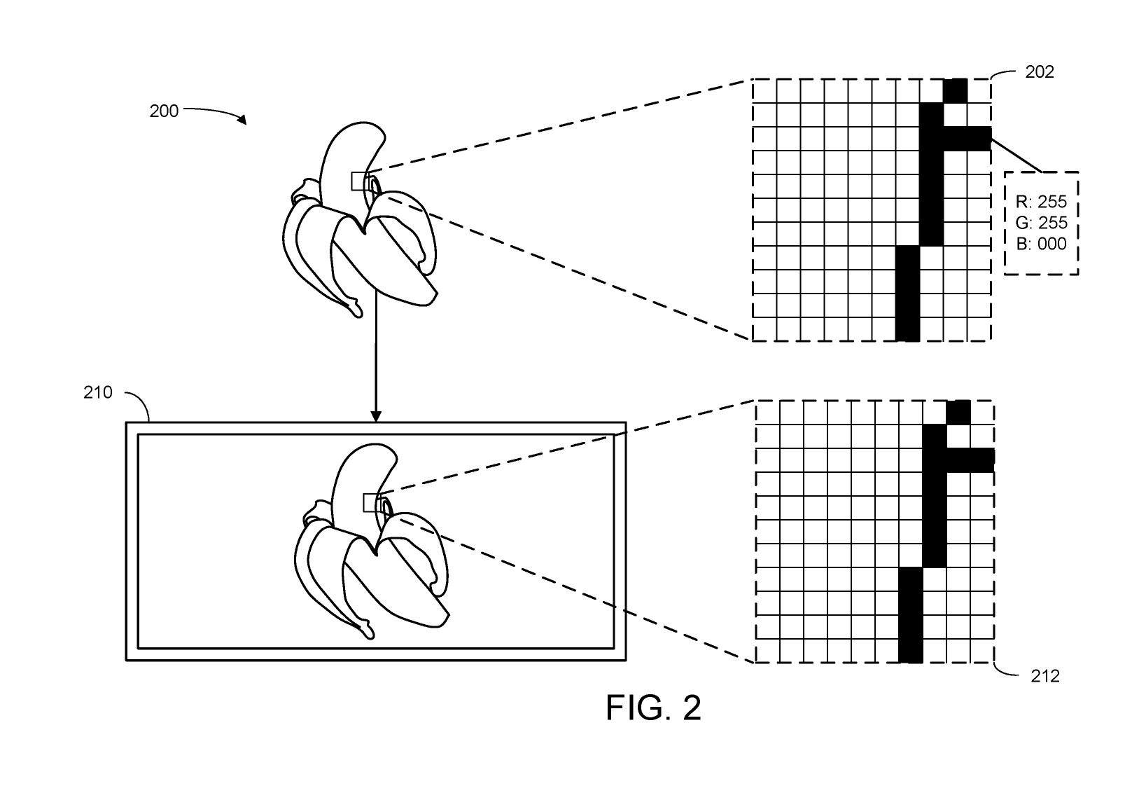

Presentation of a digital image on a near-eye display is schematically shown in FIG. 2, which shows an example digital image 200 depicting a banana. Digital image 200 is made up of a plurality of image pixels 202. Each image pixel may be defined by one or more values, such as color channel values, greyscale values, luminance values, transparency values, or depth values. In FIG. 2, example RGB color values are provided for one of the image pixels of the plurality. In some examples, each pixel may have one of two values: black or white. In other examples, image pixels may take on a variety of different colors, from any suitable color gamut. Each image pixel may have a brightness or luminance value defining how much light that image pixel should emit relative to other image pixels.

“Digital image” as used herein can apply to any digitally-stored collection of image pixels that can be received and/or stored by a virtual reality computing device and presented to a user. For example, a digital image may be a single frame of a sequence of digital image frames comprising a slideshow, video, virtual imagery (e.g., a virtual animation, object, environment), and/or a static image, such as a photograph, diagram, schematic, or other image.

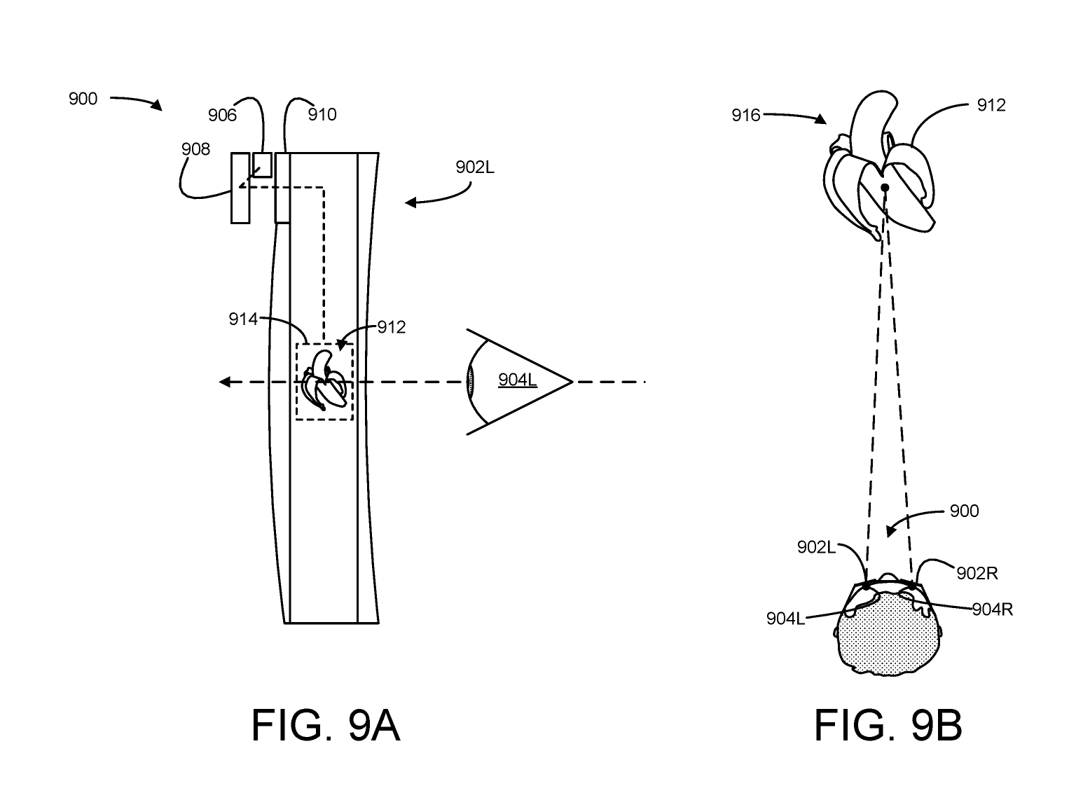

FIG. 2 also shows presentation of digital image 200 on a display 210 having a plurality of display pixels 212. Display 210 may be an example of a near-eye display usable with a virtual reality computing device, such as virtual reality computing device 102. As shown, each image pixel 202 of digital image 200 corresponds to a different display pixel 212. Each display pixel 212 may be configured to emit light with a color and intensity defined by the image pixel it is displaying. Display pixels 212 may utilize a variety of suitable technologies, as will be described below with respect to FIGS. 9 and 10. In some instances, a resolution of the digital image will match a resolution of the display, and there will be a 1:1 pixel mapping. In other instances, a resolution of the digital image will be greater than a resolution of the display, and light emitted from a display pixel may be derived from two or more image pixels. In still other instances, a resolution of the digital image will be lesser than a resolution of the display, and light emitted from two or more display pixels may be derived from a single image pixel. It is to be understood that each of the image corrections described herein can be adapted for any image/display resolutions.

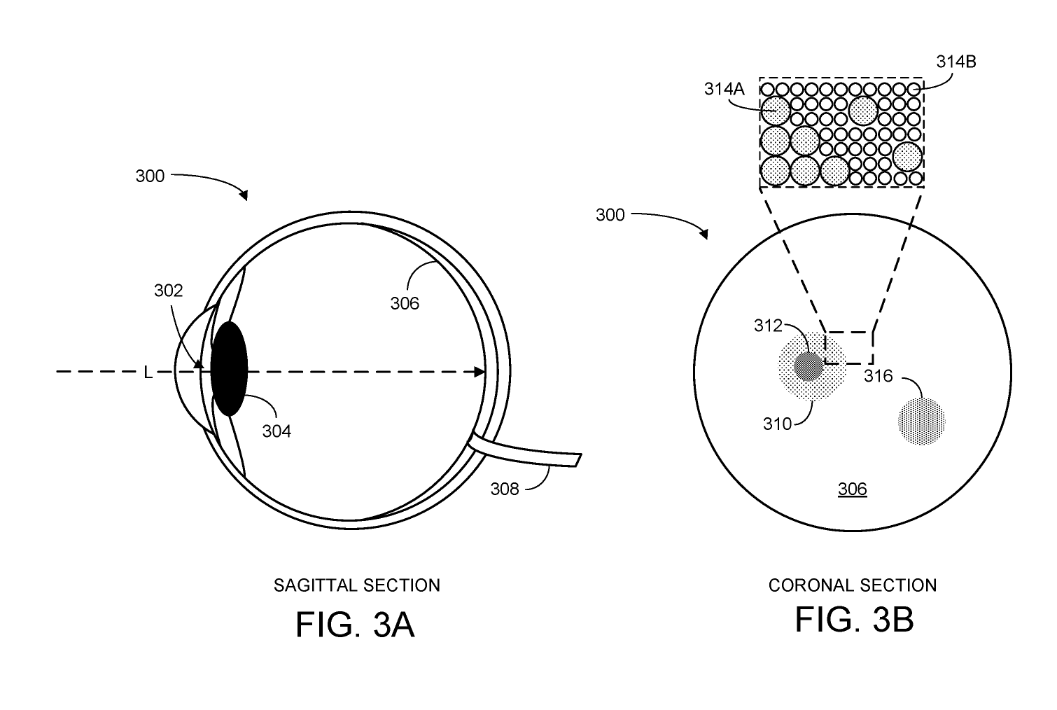

Light emitted by a display pixel may enter the eye of a user and excite one or more photoreceptors in the retina, allowing the user to see the image pixel being shown by the display pixel. This is illustrated in FIGS. 3A and 3B, which schematically show anatomical features of a human eye 300. Eye 300 may be either a left eye or a right eye of a user. The digital image modification techniques described herein may be usable with either the left eye or the right eye, and will frequently be independently performed for both eyes. It will be understood that FIGS. 3A and 3B are provided for reference, and while they do approximate the anatomy and proportions of a human eye, they are not necessarily anatomically accurate or drawn to scale.

FIG. 3A shows a sagittal section of eye 300, which has a pupil 302 and a lens 304. Light L is passing through pupil 302 and lens 304 to reach retina 306, which includes a layer of rod and cone photoreceptor cells. Light L may, for example, be light emitted by a near-eye display and originating from a particular display pixel, which may be associated with a particular image pixel of a digital image. Photoreceptors that are excited by light L then convey information regarding the intensity and color of light L to the user's brain via optic nerve 308, where it can be integrated with signals from photoreceptors excited by light originating from other display pixels, thereby allowing the user to see the digital image.

FIG. 3B shows a schematic coronal section of eye 3B, featuring retina 306. Visible in FIG. 3B is a macula 310 surrounding a fovea 312, which together represent the highest concentration of cone photoreceptors in eye 300. FIG. 3B includes a zoomed-in schematic view of photoreceptors 314 in retina 306, including cone photoreceptors 314A and rod photoreceptors 314B. Notably, the ratio of cone photoreceptors to rod photoreceptors can vary significantly in different parts of the retina, as is visible in FIG. 3B. Furthermore, cone photoreceptors occur in three varieties, each sensitive to different wavelengths of light (i.e., S-cones, M-cones, and L-cones), and the distribution of these different varieties is not uniform throughout the retina. Eye 300 also includes an optic disc 316, which contains no photoreceptors and therefore comprises an anatomical “blind spot.” This further contributes to the non-uniform distribution of photoreceptors in the retina.

As indicated above, this non-uniform distribution of photoreceptors can cause a user to perceive a digital image as though it were distorted, via inconsistent color hues, tones, or saturation. For example, if a presented digital image is a uniform blue color, the user may perceive the digital image as being more blue in some areas and less blue in others, based on the unequal distribution of blue-sensitive photoreceptors in the user's retinas. As another example, rod photoreceptors are more sensitive to light than cone photoreceptors. Accordingly, portions of a digital image that are visualized by cone photoreceptors in the macula may be seen as less bright, than portions of the digital image visualized by rod cells spread throughout the rest of the retina.

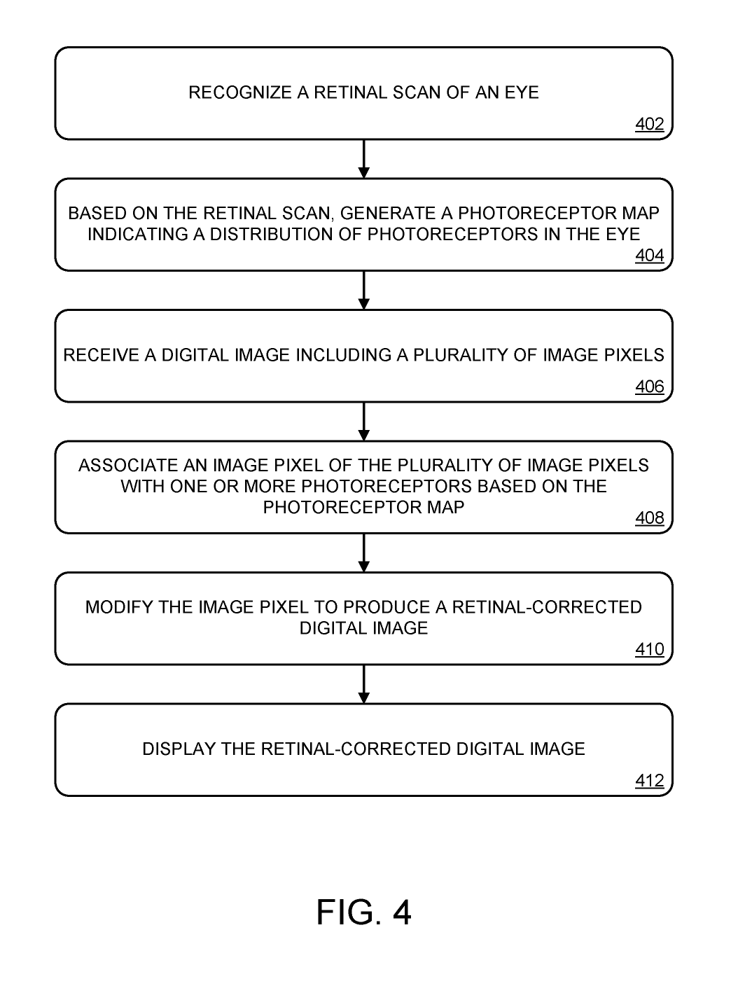

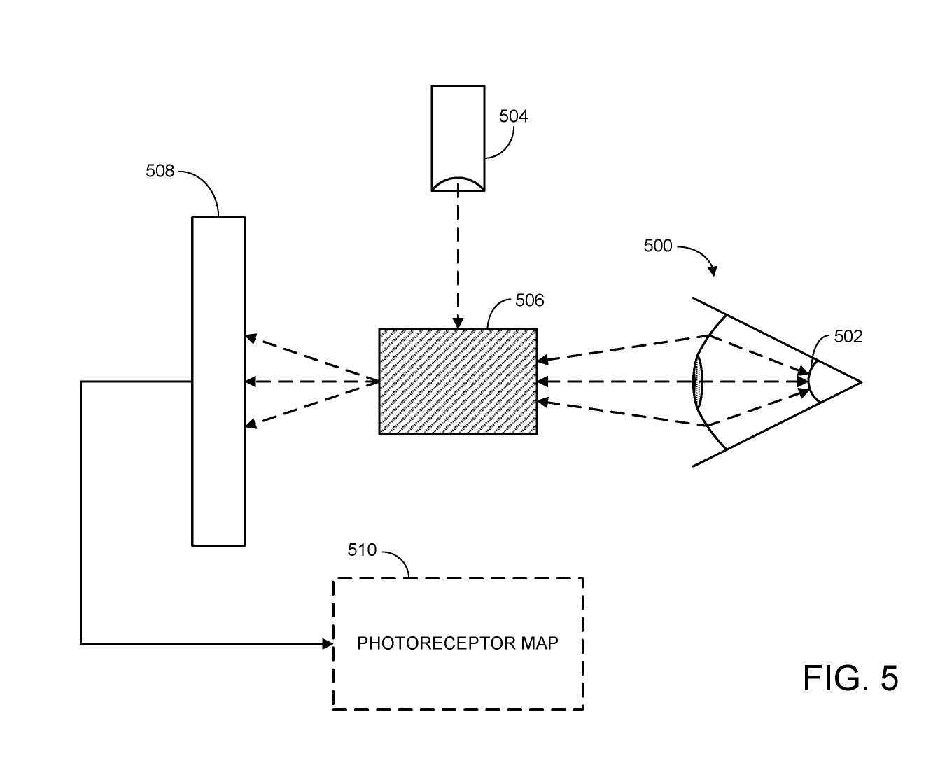

Accordingly, FIG. 4 illustrates an example method 400 for presenting digital images that mitigates distortion of digital images caused by non-uniform photoreceptor distribution. At 402, method 400 includes recognizing a retinal scan of an eye. This may include either performing a retinal scan of the eye (e.g., via a retinal scanning subsystem), or receiving a retinal scan of the eye from another source. In some implementations, a retinal scanning subsystem of a virtual reality computing device may include a low-coherence light emitter, a microbeam splitter, and a pixel sensor array. Scanning of a retina in this manner will be described below with respect to FIG. 5. In other implementations, a retinal scanning subsystem may include different components/or technologies, and may either be a component of a virtual reality computing device or separate hardware.

Furthermore, scanning of the retina may occur at any time. The retinal scan may be performed the first time the user uses the virtual reality computing device, performed when the user chooses to initiate the scan/has access to suitable scanning hardware, performed each time the user views digital images, and/or at any other suitable time. As an example, upon purchase of a virtual reality computing device, the purchaser's retina may be scanned by a dedicated retinal scanner kept at a retail store. The results of this retinal scan may be transmitted to and recognized by the virtual reality computing device. As another example, the virtual reality computing device may include a retinal scanning subsystem configured to scan the user's retina each time the user logs in. Retinal scan information optionally may be associated with a user profile so that it can be leveraged by any display device with access to the user profile.

At 404, method 400 includes, based on the retinal scan, generating a photoreceptor map indicating a distribution of photoreceptors in the eye. As used herein, “photoreceptors” need not refer to individual rod and cone photoreceptor cells. Rather, a photoreceptor map may describe retinal tissue at any suitable granularity. In an extreme example, the retinal scanning subsystem may be configured to identify gross anatomical features (e.g., the positions of the macula and optic disc), thereby capturing at least some information about the distribution of photoreceptors in the retina. In another example, the retinal scan may identify precise two-dimensional positions of each photoreceptor cell in the eye, identify which of those photoreceptor cells are rods and which are cones, and further identify, for each cone cell, the wavelengths of light that cone cell is sensitive to. In an intermediate example, the retinal scan may not have sufficient resolution to identify individual cells, though still identify clusters of cells and determine the light and/or color sensitivities of each cluster via suitable histological analyses. In other words, though the present disclosure generally describes the photoreceptor map as having information about photoreceptor position and sensitivity on the scale of individual photoreceptor cells, this need not be the case. The photoreceptor map need only have at least some information about how photoreceptors are distributed in the eye, and this information may be general or highly specific.

In general, a photoreceptor map will indicate, for each display pixel of a near-eye display, one or more photoreceptors that receive light originating from that display pixel. As described above, the photoreceptor map may describe the distribution of photoreceptors with any suitable degree of specificity or generality. Accordingly, the one or more photoreceptors that receive light from a display pixel may refer to specific individual photoreceptor cells, a cluster of multiple photoreceptor cells, a general region of the eye, etc. As an example, the photoreceptor map may include a two-dimensional position of each photoreceptor cell detected in the retinal scan, and indicate which display pixels of the near-eye display correspond to those photoreceptor cells. Further, the photoreceptor map may indicate one or both of a light sensitivity and a color sensitivity of each photoreceptor cell in the distribution. For example, for each photoreceptor cell identified in the retinal scan, the photoreceptor map may indicate whether that photoreceptor cell is a rod cell or a cone cell, and for cone cells, the photoreceptor map may describe the color sensitivity of each identified cone cell.

A photoreceptor map may be generated from a retinal scan in a variety of suitable ways. In general, performing a retinal scan will involve receiving light that has been reflected off retinal tissue. Processing on this received light can be done in order to computer-generate a three-dimensional representation of the scanned retinal tissue. Computer models can be used to detect specific features in the three-dimensional representation, and the photoreceptor map can be generated based on those features. In some cases, this may be done by a machine learning classifier previously trained to detect anatomical features based on the retinal scan. As described above, the detected features can be as general as gross anatomical features of the retina, such as the macula and optic disc. Additionally, specific histological features can be identified, such as clusters of cells or individual photoreceptor cells. Generating the photoreceptor map may further include localizing each detected feature in a coordinate system that that can be mapped to display pixels in the near-eye display. This enables the virtual reality computing device to determine which photoreceptors will receive light originating from each display pixel, as described above.

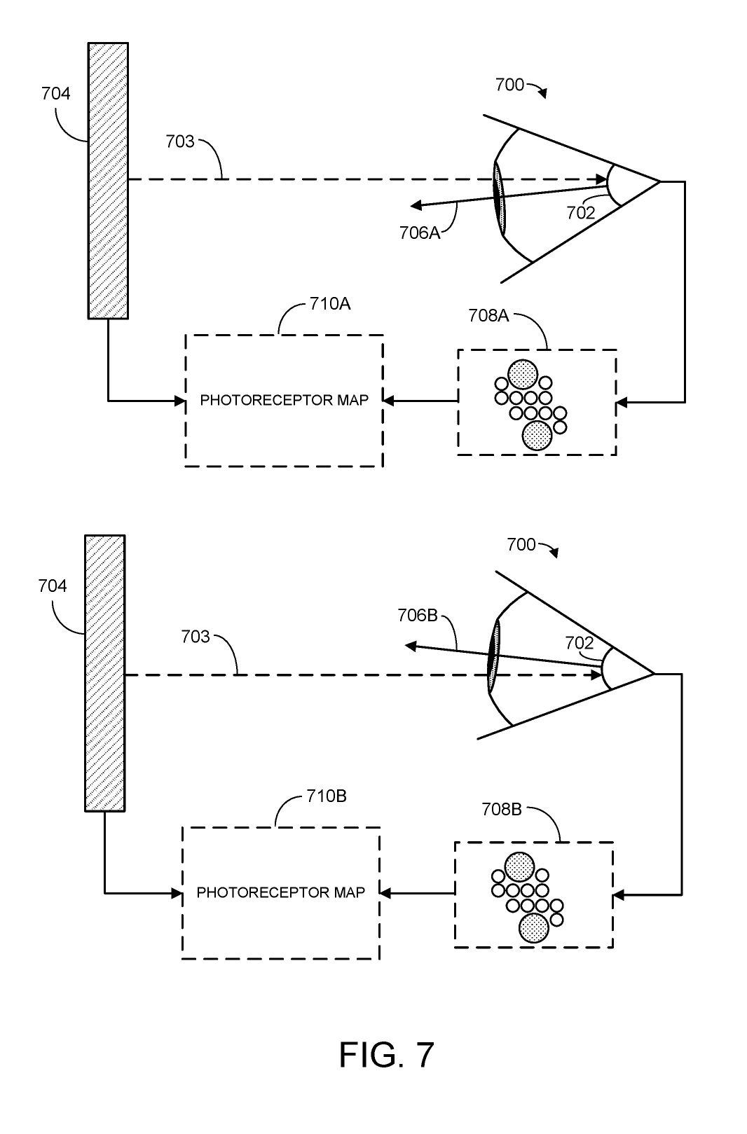

Because the positions of the photoreceptors relative to the near-eye display will change as the eye moves, the photoreceptor map can be dynamically updated based on changes in a gaze vector of the eye. This will be described below with respect to FIG. 7.

Performing a retinal scan and generating a photoreceptor map as described above is schematically illustrated in FIG. 5, which shows scanning of a human eye 500 including a retina 502. FIG. 5 also schematically shows a low-coherence light emitter 504, a light microbeam splitter 506, and a pixel sensor array 508, which may collaboratively comprise a retinal scanning subsystem. The retinal scanning subsystem may include light directing and/or focusing optics not shown for the sake of simplicity.

Transmission of light in FIG. 5 is illustrated via dashed arrows. As shown, light is emitted by low-coherence light emitter 504, and directed toward retina 502 of eye 500 by the microbeam light splitter. Upon entering eye 500, the light is reflected by the retina, causing it to pass back through the eye and be transmitted by the microbeam splitter toward the pixel sensor array. Pixel sensor array 508 then detects the light reflected from the retina. Data collected by the pixel sensor array 508 regarding the detected light is then used to generate photoreceptor map 510 based on the detected light. As described above, this may be done either by a virtual reality computing device, or a dedicated retinal scanner that produces a photoreceptor map usable by a virtual reality computing device.

In FIG. 5, light is shown entering and exiting eye 500 at positions both above and below the pupil. It will be understood that the human eye only admits light through the pupil, and the drawing is intended to illustrate how light may enter an eye from multiple angles, and similarly be reflected from the retina at multiple angles (if the pupil is gazing in a direction that admits light from that angle).

The particular method of scanning the retina shown in FIG. 5 is described herein in simple, schematic terms, and is only provided as an example of how retinal scanning may be performed. In general, any suitable technologies and hardware components may be used to scan the retina of an eye, provided sufficient data is captured for generating a photoreceptor map. Further, in some implementations, digital image modification as described herein may not be performed based on a personalized photoreceptor map for a user. Rather, the virtual reality computing device may modify digital images according to a generic photoreceptor map that describes a general photoreceptor distribution of the average human. In some cases, this generic photoreceptor map may serve as a default photoreceptor map that can be optionally augmented with data from a retinal scan, should a user undergo such a scan.

Returning to FIG. 4, at 406, method 400 includes receiving a digital image including a plurality of image pixels. For example, the virtual reality computing device may receive a digital image such as digital image 200 described above with respect to FIG. 2. It will be understood that a virtual reality computing device may receive virtually any digital image, which may have any suitable appearance and include any number of image pixels. As described above, a received digital image may be rendered by the virtual reality computing device as part of a sequence of digital image frames comprising a slideshow, video, virtual image (e.g., a virtual animation, object, environment), and/or a static image, such as a photograph, diagram, schematic, or other image.

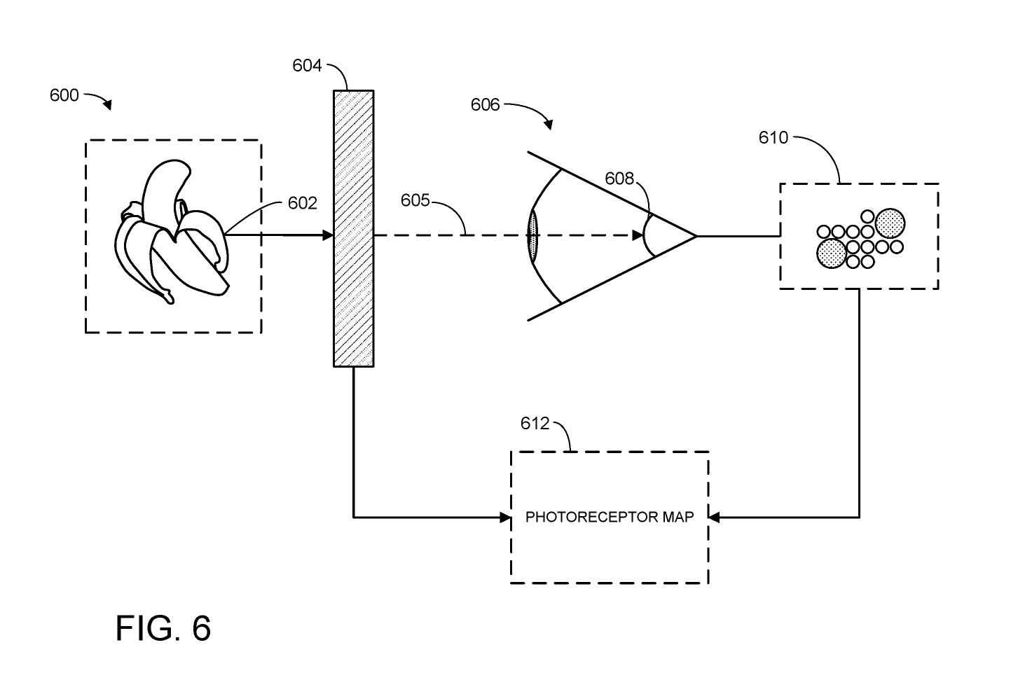

At 408, method 400 includes associating an image pixel of the plurality of image pixels with one or more photoreceptors of the eye based on the photoreceptor map. This is schematically illustrated in FIG. 6, which shows an example digital image 600 having a plurality of image pixels, including a particular image pixel 602. Digital image 600 is presented by a near-eye display 604. Though display pixels are not shown in FIG. 6, it will be understood that, as with other near-eye displays described herein, near-eye display 604 includes a plurality of display pixels, each of which is configured to display light based on one or more image pixels of the digital image. In the illustrated example, light 605 is displayed by a specific display pixel of the near-eye display that corresponds to image pixel 602.

It will be understood that image pixels of a digital image may be modified before the digital image is presented, such that the image that is ultimately presented to the user is a retinal-corrected digital image, as will be described below.

FIG. 6 also shows a human eye 606 including a retina 608. As shown, light emitted from the display pixel representing image pixel 602 enters eye 606 and reaches retina 608, where it activates one or more photoreceptors. These are shown in FIG. 6 as photoreceptors 610, shown in an example schematic zoomed-in view of the portion of retina 608 at which light representing image pixel 602 is received.

FIG. 6 also shows a photoreceptor map 612. As described above, photoreceptor map 612 indicates, for each display pixel of the near-eye display, one or more photoreceptors that receive light originating from that display pixel. Accordingly, using the photoreceptor map, the virtual reality computing device can determine in advance which photoreceptors in retina 608 will receive light from each display pixel of the near-eye display. The virtual reality computing device can then determine at which display pixel each image pixel will be shown, and therefore identify the one or more photoreceptors that will receive light corresponding to each image pixel.

As indicated above, movement of an eye can cause the positions of photoreceptors in the retina to change relative to display pixels in the near-eye display. This can render a generated photoreceptor map obsolete each time a user moves his or her eye(s), as display pixels of the near-eye display will no longer correspond to the photoreceptors described by the photoreceptor map. Accordingly, a virtual reality computing device may track a gaze vector of an eye, and as the gaze vector changes, dynamically update the photoreceptor map.

Updating of the photoreceptor map may be done by shifting the two-dimensional positions of the anatomical features detected from the retinal scan to new two-dimensional positions based on the new gaze vector. In other words, the photoreceptor map may be updated for each display pixel to indicate the one or more photoreceptors that receive light from that display pixel based on the new gaze vector of the eye. This may in some cases occur each time a new digital image is received by the virtual reality computing device (e.g., the photoreceptor map is updated for each frame of a video or animation), or each time an eye movement is detected. A variety of gaze-tracking technologies may be used to detect a current gaze vector of an eye. Example gaze-tracking techniques usable with a virtual reality computing device are described below with respect to FIG. 10.

Tracking of a gaze vector of an eye is schematically illustrated in FIG. 7. Specifically, FIG. 7 shows a human eye 700 having a retina 702 and receiving light 703 emitted by a near-eye display 704. Eye 700 is shown having two different gaze vectors 706A and 706B. When eye 700 has gaze vector 706A it is focusing on a point toward the bottom of the near-eye display, causing light 703 from a display pixel in the middle of the display to reach photoreceptors 708A near the top of retina 702. Accordingly, the display pixel emitting the light 703 shown in FIG. 7 may be associated with photoreceptors 708A based on photoreceptor map 710A, which maps anatomical features of retina 702 to display pixels of near-eye display 704 while eye 700 has gaze vector 706A.

When the orientation of eye 700 changes to have gaze vector 706B, it is focusing on a point near the top of near-eye display 704, causing light 703 from the same display pixel to reach photoreceptors 708B near the bottom of retina 702. Accordingly, photoreceptor map 710A is updated by the virtual reality computing device to photoreceptor map 710B, which maps anatomical features of retina 702 to display pixels of near-eye display 704 while eye 700 has gaze vector 710B.

Returning to FIG. 4, at 410, method 400 includes modifying the image pixel to produce a retinal-corrected digital image. The image pixel may be modified based on one or both of a light sensitivity and a color sensitivity of the one or more photoreceptors associated with the image pixel. For example, modifying the image pixel may include decreasing a brightness of the image pixel if the image pixel is associated primarily with rod photoreceptors. Similarly, the brightness of the image pixel may be increased if the image pixel is associated primarily with cone photoreceptors. In cases where the photoreceptor map has information regarding the color sensitivity of photoreceptors in the retina, modifying the image pixel may include increasing a color intensity of the image pixel if it is associated primarily with rod photoreceptors. Similarly, a color intensity of the image pixel may be decreased if it is associated primarily with cone photoreceptors.

The criteria used to determine whether an image pixel is “associated primarily” with a certain type of photoreceptor may depend on the specificity with which the photoreceptor map describes the distribution of photoreceptors. In an example where the photoreceptor map describes the two-dimensional positions of each rod and cone photoreceptor cell, then a particular image pixel may be “associated primarily” with rod photoreceptors if more than a threshold percent (e.g., 70%) of the photoreceptor cells activated by light from that image pixel are rod cells. In other examples, other criteria may be used (e.g., when the photoreceptor map has a different level of detail). In an example where the photoreceptor map only has information about gross anatomical features of the eye, then an image pixel may be “associated primarily” with cone photoreceptors if light from the image pixel reaches a part of the retina corresponding to the macula or fovea.

In cases where the photoreceptor map has sufficient detail to identify the color sensitivities of individual cone photoreceptor cells, then image pixel modification may be performed based on those color sensitivities. For example, modifying the image pixel may include increasing a specific color intensity of a specific color of the image pixel if the image pixel is associated primarily with cone photoreceptors insensitive to that color. In other words, if an image pixel is associated with a group of cone photoreceptor cells that includes few or no S-cones, then a “blue” intensity of the image pixel may be increased to account for the reduced blue sensitivity in that part of the retina.

The specific modifications described above are not intended to limit the present disclosure. In general, an image pixel can be modified in virtually any way, according to any information a virtual reality computing device has regarding a user's photoreceptor distribution and/or retinal anatomy. For example, a virtual reality computing device may reduce the brightness or entirely blank any image pixels associated with the optic disc of an eye, as there are no photoreceptors in that region. Similarly, the virtual reality computing device may have information that the user lacks a certain variety of cone photoreceptor (corresponding to some form of colorblindness) and modify image pixels of a digital image accordingly.

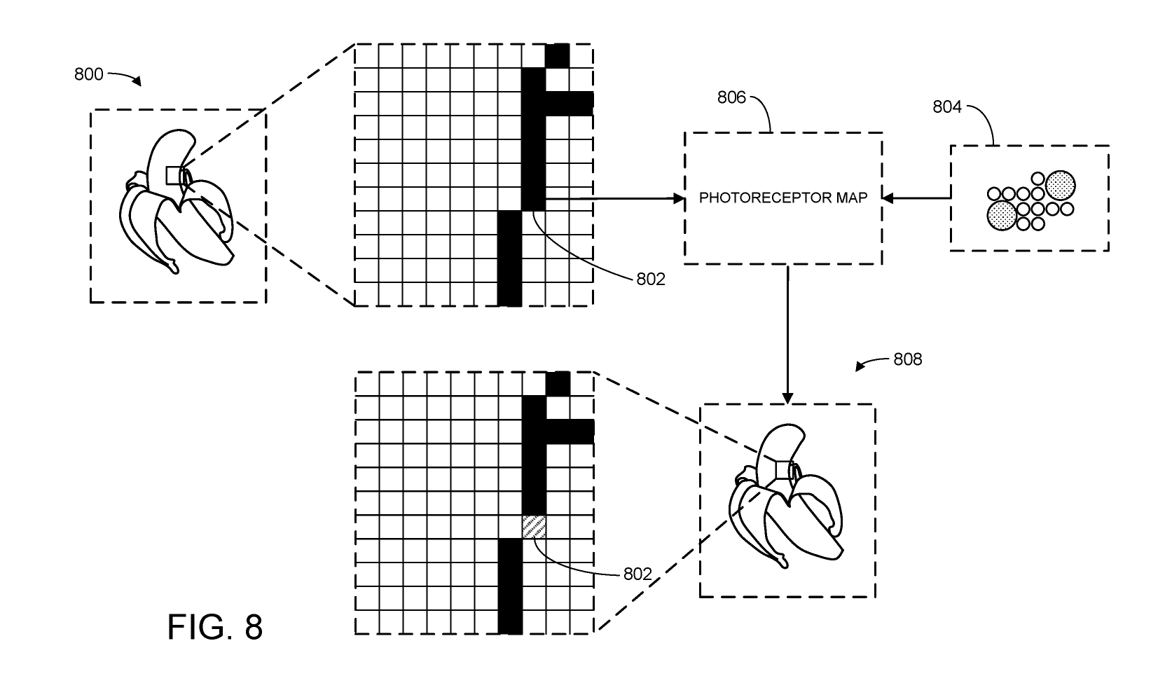

Modification of an image pixel of a digital image is schematically illustrated in FIG. 8. FIG. 8 shows a digital image 800 having a plurality of image pixels, including a particular image pixel 802. Image pixel 802 is associated with a group of photoreceptors 804 in a retina of an eye via a photoreceptor map 806, which may be generated as described above. Image pixel 802 is modified based on one or both of a light sensitivity and a color sensitivity of photoreceptors 804, resulting in a retinal-corrected digital image 808, shown with a modified image pixel 802. As described above, a wide variety of modifications can be performed on a particular image pixel based on information regarding the distribution of photoreceptors in a user's retina.

It will be appreciated that similar pixel modifications may be performed for one to all image pixels in the same image. In other words, the virtual reality computing device may be configured to modify other image pixels of the plurality of image pixels based on a light sensitivity of one or more photoreceptors associated with the other image pixels.

Similarly digital modification may be performed for both eyes. Different left and right digital images can be rendered and modified for the user's left and right eyes. For example, the above-described modification may be done for a left eye of a user, and the above-described digital image may be a left digital image. The virtual reality computing device may be configured to also associate an image pixel of a right digital image with one or more photoreceptors of a right eye of the user, and modify the image pixel based on a light sensitivity of the one or more photoreceptors of the right eye.

Returning briefly to FIG. 4, at 412, method 400 includes displaying the retinal-corrected digital image. This may be done via a near-eye display having a plurality of display pixels, as described above. For example, retinal-corrected digital image 808 shown in FIG. 8 may be displayed via near-eye display 210, shown in FIG. 2.

Displaying of a digital image may be performed in a variety of ways using a variety of suitable technologies. For example, in some implementations, the near-eye display associated with a virtual reality computing device may include two or more microprojectors, each configured to project light on or within the near-eye display. FIG. 9A shows a portion of an example near-eye display 900. Near-eye display 900 includes a left microprojector 902L situated in front of a user's left eye 904L. It will be appreciated that near-eye display 900 also includes a right microprojector 902R situated in front of the user's right eye 904R, not visible in FIG. 9A.

The near-eye display includes a light source 906 and a liquid-crystal-on-silicon (LCOS) array 908. The light source may include an ensemble of light-emitting diodes (LEDs)—e.g., white LEDs or a distribution of red, green, and blue LEDs. The light source may be situated to direct its emission onto the LCOS array, which is configured to form a display image based on control signals received from a logic machine associated with a virtual reality computing device. The LCOS array may include numerous individually addressable display pixels arranged on a rectangular grid or other geometry, each of which is usable to show an image pixel of a digital image. In some embodiments, pixels reflecting red light may be juxtaposed in the array to pixels reflecting green and blue light, so that the LCOS array forms a color image. In other embodiments, a digital micromirror array may be used in lieu of the LCOS array, or an active-matrix LED array may be used instead. In still other embodiments, transmissive, backlit LCD or scanned-beam technology may be used to form the display image.

In some embodiments, the display image from LCOS array 908 may not be suitable for direct viewing by the user of near-eye display 900. In particular, the display image may be offset from the user's eye, may have an undesirable vergence, and/or a very small exit pupil (i.e., area of release of display light, not to be confused with the user's anatomical pupil). In view of these issues, the display image from the LCOS array may be further conditioned en route to the user's eye. For example, light from the LCOS array may pass through one or more lenses, such as lens 910, or other optical components of near-eye display 900, in order to reduce any offsets, adjust vergence, expand the exit pupil, etc.

Light projected by each microprojector 902 may take the form of a digital image visible to a user, and occupy a particular screen-space position relative to the near-eye display, defined by a range of display pixels used to display the image. As shown, light from LCOS array 908 is forming digital image 912 at screen-space position 914. Specifically, digital image 912 is a banana, though any other virtual imagery may be displayed. A similar image may be formed by microprojector 902R, and occupy a similar screen-space position relative to the user's right eye. In some implementations, these two images may be offset from each other in such a way that they are interpreted by the user's visual cortex as a single, three-dimensional image. Accordingly, the user may perceive the images projected by the microprojectors as a three-dimensional object occupying a three-dimensional world-space position that is behind the screen-space position at which the virtual image is presented by the near-eye display.

This is shown in FIG. 9B, which shows an overhead view of a user wearing near-eye display 900. As shown, left microprojector 902L is positioned in front of the user's left eye 904L, and right microprojector 902R is positioned in front of the user's right eye 904R. Virtual image 912 is visible to the user as a virtual object present at a three-dimensional world-space position 914. In some cases, the user may move the virtual object such that it appears to occupy a different three-dimensional position. Additionally, or alternatively, movement of the user may cause a pose of the virtual reality computing device to change, requiring the virtual reality computing device to use different display pixels to present the virtual object so as to give the illusion that the virtual object has not moved relative to the user.

FIG. 10 shows aspects of an example virtual-reality computing system 1000 including a near-eye display 1002. The virtual-reality computing system 1000 is a non-limiting example of the virtual-reality computing devices described above, and may be usable for displaying and modifying digital images according to a user's photoreceptor distribution. Virtual reality computing system 1000 may be implemented as computing system 1100 shown in FIG. 11.

The virtual-reality computing system 1000 may be configured to present any suitable type of virtual-reality experience. In some implementations, the virtual-reality experience includes a totally virtual experience in which the near-eye display 1002 is opaque, such that the wearer is completely absorbed in the virtual-reality imagery provided via the near-eye display 1002.

In some implementations, the virtual-reality experience includes an augmented-reality experience in which the near-eye display 1002 is wholly or partially transparent from the perspective of the wearer, to give the wearer a clear view of a surrounding physical space. In such a configuration, the near-eye display 1002 is configured to direct display light to the user's eye(s) so that the user will see augmented-reality objects that are not actually present in the physical space. In other words, the near-eye display 1002 may direct display light to the user's eye(s) while light from the physical space passes through the near-eye display 1002 to the user's eye(s). As such, the user's eye(s) simultaneously receive light from the physical environment and display light.

In such augmented-reality implementations, the virtual-reality computing system 1000 may be configured to visually present augmented-reality objects that appear body-locked and/or world-locked. A body-locked augmented-reality object may appear to move along with a perspective of the user as a pose (e.g., six degrees of freedom (DOF): x, y, z, yaw, pitch, roll) of the virtual-reality computing system 1000 changes. As such, a body-locked, augmented-reality object may appear to occupy the same portion of the near-eye display 1002 and may appear to be at the same distance from the user, even as the user moves in the physical space. Alternatively, a world-locked, augmented-reality object may appear to remain in a fixed location in the physical space, even as the pose of the virtual-reality computing system 1000 changes. When the virtual-reality computing system 1000 visually presents world-locked, augmented-reality objects, such a virtual-reality experience may be referred to as a mixed-reality experience.

In some implementations, the opacity of the near-eye display 1002 is controllable dynamically via a dimming filter. A substantially see-through display, accordingly, may be switched to full opacity for a fully immersive virtual-reality experience.

The virtual-reality computing system 1000 may take any other suitable form in which a transparent, semi-transparent, and/or non-transparent display is supported in front of a viewer's eye(s). Further, implementations described herein may be used with any other suitable computing device, including but not limited to wearable computing devices, mobile computing devices, laptop computers, desktop computers, smart phones, tablet computers, etc.

Any suitable mechanism may be used to display images via the near-eye display 1002. For example, the near-eye display 1002 may include image-producing elements located within lenses 1006. As another example, the near-eye display 1002 may include a display device, such as a liquid crystal on silicon (LCOS) device or OLED microdisplay located within a frame 1008. In this example, the lenses 1006 may serve as, or otherwise include, a light guide for delivering light from the display device to the eyes of a wearer. Additionally or alternatively, the near-eye display 1002 may present left-eye and right-eye virtual-reality images via respective left-eye and right-eye displays.

The virtual-reality computing system 1000 includes an on-board computer 1004 configured to perform various operations related to receiving user input (e.g., gesture recognition, eye gaze detection), visual presentation of virtual-reality images on the near-eye display 1002, and other operations described herein. In some implementations, some to all of the computing functions described above, may be performed off board.

The virtual-reality computing system 1000 may include various sensors and related systems to provide information to the on-board computer 1004. Such sensors may include, but are not limited to, one or more inward facing image sensors 1010A and 1010B, one or more outward facing image sensors 1012A and 10123B, an inertial measurement unit (IMU) 1014, and one or more microphones 1016. The one or more inward facing image sensors 1010A, 1010B may be configured to acquire gaze tracking information from a wearer's eyes (e.g., sensor 1010A may acquire image data for one of the wearer's eye and sensor 1010B may acquire image data for the other of the wearer's eye).

The on-board computer 1004 may be configured to determine gaze directions of each of a wearer's eyes in any suitable manner based on the information received from the image sensors 1010A, 1010B. The one or more inward facing image sensors 1010A, 1010B, and the on-board computer 1004 may collectively represent a gaze detection machine configured to determine a wearer's gaze target on the near-eye display 1002. In other implementations, a different type of gaze detector/sensor may be employed to measure one or more gaze parameters of the user's eyes. Examples of gaze parameters measured by one or more gaze sensors that may be used by the on-board computer 1004 to determine an eye gaze sample may include an eye gaze direction, head orientation, eye gaze velocity, eye gaze acceleration, change in angle of eye gaze direction, and/or any other suitable tracking information. In some implementations, eye gaze tracking may be recorded independently for both eyes.

The one or more outward facing image sensors 1012A, 1012B may be configured to measure physical environment attributes of a physical space. In one example, image sensor 1012A may include a visible-light camera configured to collect a visible-light image of a physical space. Further, the image sensor 1012B may include a depth camera configured to collect a depth image of a physical space. More particularly, in one example, the depth camera is an infrared time-of-flight depth camera. In another example, the depth camera is an infrared structured light depth camera.

Data from the outward facing image sensors 1012A, 1012B may be used by the on-board computer 1004 to detect movements, such as gesture-based inputs or other movements performed by a wearer or by a person or physical object in the physical space. In one example, data from the outward facing image sensors 1012A, 1012B may be used to detect a wearer input performed by the wearer of the virtual-reality computing system 1000, such as a gesture. Data from the outward facing image sensors 1012A, 1012B may be used by the on-board computer 1004 to determine direction/location and orientation data (e.g., from imaging environmental features) that enables position/motion tracking of the virtual-reality computing system 1000 in the real-world environment. In some implementations, data from the outward facing image sensors 1012A, 1012B may be used by the on-board computer 1004 to construct still images and/or video images of the surrounding environment from the perspective of the virtual-reality computing system 1000.

The IMU 1014 may be configured to provide position and/or orientation data of the virtual-reality computing system 1000 to the on-board computer 1004. In one implementation, the IMU 1014 may be configured as a three-axis or three-degree of freedom (3DOF) position sensor system. This example position sensor system may, for example, include three gyroscopes to indicate or measure a change in orientation of the virtual-reality computing system 1000 within 3D space about three orthogonal axes (e.g., roll, pitch, and yaw).

In another example, the IMU 1014 may be configured as a six-axis or six-degree of freedom (6DOF) position sensor system. Such a configuration may include three accelerometers and three gyroscopes to indicate or measure a change in location of the virtual-reality computing system 1000 along three orthogonal spatial axes (e.g., x, y, and z) and a change in device orientation about three orthogonal rotation axes (e.g., yaw, pitch, and roll). In some implementations, position and orientation data from the outward facing image sensors 1012A, 1012B and the IMU 1014 may be used in conjunction to determine a position and orientation (or 6DOF pose) of the virtual-reality computing system 1000.

The virtual-reality computing system 1000 may also support other suitable positioning techniques, such as GPS or other global navigation systems. Further, while specific examples of position sensor systems have been described, it will be appreciated that any other suitable sensor systems may be used. For example, head pose and/or movement data may be determined based on sensor information from any combination of sensors mounted on the wearer and/or external to the wearer including, but not limited to, any number of gyroscopes, accelerometers, inertial measurement units, GPS devices, barometers, magnetometers, cameras (e.g., visible light cameras, infrared light cameras, time-of-flight depth cameras, structured light depth cameras, etc.), communication devices (e.g., WIFI antennas/interfaces), etc.

The one or more microphones 1016 may be configured to measure sound in the physical space. Data from the one or more microphones 1016 may be used by the on-board computer 1004 to recognize voice commands provided by the wearer to control the virtual-reality computing system 1000.

The on-board computer 1004 may include a logic machine and a storage machine, discussed in more detail below with respect to FIG. 10, in communication with the near-eye display 1002 and the various sensors of the virtual-reality computing system 1000.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 11 schematically shows a non-limiting embodiment of a computing system 1100 that can enact one or more of the methods and processes described above. Computing system 1100 is shown in simplified form. Computing system 1100 may take the form of one or more personal computers, server computers, tablet computers, home-entertainment computers, network computing devices, gaming devices, virtual reality computing devices, mobile computing devices, mobile communication devices (e.g., smart phone), and/or other computing devices.

Computing system 1100 includes a logic machine 1102 and a storage machine 1104. Computing system 1100 may optionally include a display subsystem 1106, input subsystem 1108, communication subsystem 1110, and/or other components not shown in FIG. 11.

Logic machine 1102 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 1104 includes one or more physical devices configured to hold instructions executable by the logic machine to implement the methods and processes described herein. When such methods and processes are implemented, the state of storage machine 1104 may be transformed—e.g., to hold different data.

Storage machine 1104 may include removable and/or built-in devices. Storage machine 1104 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 1104 may include volatile, nonvolatile, dynamic, static, read/write, read-only, random-access, sequential-access, location-addressable, file-addressable, and/or content-addressable devices.

It will be appreciated that storage machine 1104 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 1102 and storage machine 1104 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 1100 implemented to perform a particular function. In some cases, a module, program, or engine may be instantiated via logic machine 1102 executing instructions held by storage machine 1104. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 1106 may be used to present a visual representation of data held by storage machine 1104. This visual representation may take the form of a graphical user interface (GUI). As the herein described methods and processes change the data held by the storage machine, and thus transform the state of the storage machine, the state of display subsystem 1106 may likewise be transformed to visually represent changes in the underlying data. Display subsystem 1106 may include one or more display devices utilizing virtually any type of technology. Such display devices may be combined with logic machine 1102 and/or storage machine 1104 in a shared enclosure, or such display devices may be peripheral display devices.

When included, input subsystem 1108 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1110 may be configured to communicatively couple computing system 1100 with one or more other computing devices. Communication subsystem 1110 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1100 to send and/or receive messages to and/or from other devices via a network such as the Internet.

In an example, a method for presenting digital images comprises: recognizing a retinal scan of an eye; based on the retinal scan, generating a photoreceptor map indicating a distribution of photoreceptors in the eye; receiving a digital image including a plurality of image pixels; associating an image pixel of the plurality of image pixels with one or more photoreceptors of the eye based on the photoreceptor map; modifying the image pixel to produce a retinal-corrected digital image, where the image pixel is modified based on a light sensitivity of the one or more photoreceptors associated with the image pixel; and displaying the retinal-corrected digital image to a user via a near-eye display. In this example or any other example, the near-eye display includes a plurality of display pixels; each image pixel of the plurality of image pixels is shown at a different display pixel of the near-eye display; the photoreceptor map indicates, for each display pixel, one or more photoreceptors that receive light originating from that display pixel; and associating the image pixel with one or more photoreceptors includes determining at which display pixel the image pixel will be shown, and identifying, via the photoreceptor map, the one or more photoreceptors that receive light originating from that display pixel. In this example or any other example, the method further comprises tracking a gaze vector of the eye and, as the gaze vector changes, dynamically updating the photoreceptor map for each display pixel to indicate one or more photoreceptors that receive light from that display pixel based on a current gaze vector of the eye. In this example or any other example, scanning the retina of the eye is done by a retinal scanning subsystem comprising a low-coherence light emitter, a microbeam splitter, and a pixel sensor array. In this example or any other example, scanning the retina of the eye includes directing low-coherence light from the low-coherence light emitter toward the retina and detecting light reflected from the retina with the pixel sensor array, and the photoreceptor map is generated based on the detected light. In this example or any other example, the photoreceptor map is generated using a machine learning classifier that identifies rod and cone photoreceptors in the eye based on the retinal scan. In this example or any other example, modifying the image pixel includes decreasing a brightness of the image pixel if the image pixel is associated primarily with cone photoreceptors. In this example or any other example, modifying the image pixel includes increasing a brightness of the image pixel if the image pixel is associated primarily with rod photoreceptors. In this example or any other example, the photoreceptor map indicates a color sensitivity for each photoreceptor in the distribution of photoreceptors. In this example or any other example, modifying the image pixel includes increasing an overall color intensity of the image pixel if the image pixel is associated primarily with rod photoreceptors. In this example or any other example, modifying the image pixel includes increasing a specific color intensity of a specific color of the image pixel if the image pixel is associated primarily with cone photoreceptors insensitive to the specific color. In this example or any other example, modifying the image pixel includes decreasing a color intensity of the image pixel if the image pixel is associated primarily with cone photoreceptors. In this example or any other example, the method further comprises modifying other image pixels of the plurality of image pixels based on a light sensitivity of one or more photoreceptors associated with the other image pixels. In this example or any other example, the eye is a left eye of a user and the digital image is a left digital image, and the method further comprises modifying a right digital image for display to a right eye of the user.

In an example, a virtual reality computing device comprises: a near-eye display; a logic machine; and a storage machine holding instructions executable by the logic machine to: recognize a retinal scan of an eye; based on the retinal scan, generate a photoreceptor map indicating a distribution of photoreceptors in the eye; receive a digital image including a plurality of image pixels; associate an image pixel of the plurality of image pixels with one or more photoreceptors of the eye based on the photoreceptor map; modify the image pixel to produce a retinal-corrected digital image, where the image pixel is modified based on a light sensitivity of the one or more photoreceptors associated with the image pixel; and display the retinal-corrected digital image to a user via the near-eye display. In this example or any other example, the near-eye display includes a plurality of display pixels; each image pixel of the plurality of image pixels is shown at a different display pixel of the near-eye display; the photoreceptor map indicates, for each display pixel, one or more photoreceptors that receive light originating from that display pixel; and associating the image pixel with one or more photoreceptors includes determining at which display pixel the image pixel will be shown, and identifying, via the photoreceptor map, the one or more photoreceptors that receive light originating from that display pixel. In this example or any other example, the instructions are further executable to track a gaze vector of the eye and, as the gaze vector changes, dynamically update the photoreceptor map for each display pixel to indicate one or more photoreceptors that receive light from that display pixel based on a current gaze vector of the eye. In this example or any other example, the photoreceptor map indicates a color sensitivity for each photoreceptor in the distribution of photoreceptors, and modifying the image pixel includes increasing a specific color intensity of a specific color of the image pixel if the image pixel is associated primarily with cone photoreceptors poorly insensitive to the specific color. In this example or any other example, the photoreceptor map is generated using a machine learning classifier that identifies rod and cone photoreceptors in the eye based on the retinal scan.

In an example, a virtual reality computing device comprises: a near-eye display including a plurality of display pixels; a retinal scanner; a logic machine; and a storage machine holding instructions executable by the logic machine to: perform a retinal scan of an eye with the retinal scanner; based on the retinal scan, generate a photoreceptor map indicating a distribution of photoreceptors in the eye, a light sensitivity and a color sensitivity for each photoreceptor in the distribution, and for each display pixel of the near-eye display, one or more photoreceptors that receive light originating from that display pixel; receive a digital image including a plurality of image pixels; for an image pixel of the plurality of image pixels, identify a particular display pixel at which the image pixel will be shown; associate the image pixel with one or more photoreceptors that receive light originating from the particular display pixel; modify the image pixel to produce a retinal-corrected digital image, where the image pixel is modified based on the light sensitivity and the color sensitivity of the one or more photoreceptors associated with the image pixel; and display the retinal-corrected digital image to a user via the near-eye display.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents, thereof.

1. A method for presenting digital images, comprising:
recognize a retinal scan of an eye;
based on the retinal scan, generating a photoreceptor map indicating a distribution of photoreceptors in the eye;
receiving a digital image including a plurality of image pixels;
associating an image pixel of the plurality of image pixels with one or more photoreceptors of the eye based on the photoreceptor map;
modifying the image pixel to produce a retinal-corrected digital image, where the image pixel is modified based on a light sensitivity of the one or more photoreceptors associated with the image pixel; and
displaying the retinal-corrected digital image to a user via a near-eye display.

2. The method of claim 1, where:
the near-eye display includes a plurality of display pixels;
each image pixel of the plurality of image pixels is shown at a different display pixel of the near-eye display;
the photoreceptor map indicates, for each display pixel, one or more photoreceptors that receive light originating from that display pixel; and
associating the image pixel with one or more photoreceptors includes determining at which display pixel the image pixel will be shown, and identifying, via the photoreceptor map, the one or more photoreceptors that receive light originating from that display pixel.

3. The method of claim 2, further comprising tracking a gaze vector of the eye and, as the gaze vector changes, dynamically updating the photoreceptor map for each display pixel to indicate one or more photoreceptors that receive light from that display pixel based on a current gaze vector of the eye.

4. The method of claim 1, where scanning the retina of the eye is done by a retinal scanning subsystem comprising a low-coherence light emitter, a microbeam splitter, and a pixel sensor array.

5. The method of claim 4, where scanning the retina of the eye includes directing low-coherence light from the low-coherence light emitter toward the retina and detecting light reflected from the retina with the pixel sensor array, and where the photoreceptor map is generated based on the detected light.

6. The method of claim 1, where the photoreceptor map is generated using a machine learning classifier that identifies rod and cone photoreceptors in the eye based on the retinal scan.

7. The method of claim 1, where modifying the image pixel includes decreasing a brightness of the image pixel if the image pixel is associated primarily with cone photoreceptors.

8. The method of claim 1, where modifying the image pixel includes increasing a brightness of the image pixel if the image pixel is associated primarily with rod photoreceptors.

9. The method of claim 1, where the photoreceptor map indicates a color sensitivity for each photoreceptor in the distribution of photoreceptors.

10. The method of claim 9, where modifying the image pixel includes increasing an overall color intensity of the image pixel if the image pixel is associated primarily with rod photoreceptors.

11. The method of claim 9, where modifying the image pixel includes increasing a specific color intensity of a specific color of the image pixel if the image pixel is associated primarily with cone photoreceptors insensitive to the specific color.

12. The method of claim 9, where modifying the image pixel includes decreasing a color intensity of the image pixel if the image pixel is associated primarily with cone photoreceptors.

13. The method of claim 1, further comprising modifying other image pixels of the plurality of image pixels based on a light sensitivity of one or more photoreceptors associated with the other image pixels.

14. The method of claim 1, where the eye is a left eye of a user and the digital image is a left digital image, and the method further comprises modifying a right digital image for display to a right eye of the user.

15. A virtual reality computing device, comprising:
a near-eye display;
a logic machine; and
a storage machine holding instructions executable by the logic machine to:
recognize a retinal scan of an eye;
based on the retinal scan, generate a photoreceptor map indicating a distribution of photoreceptors in the eye;
receive a digital image including a plurality of image pixels;
associate an image pixel of the plurality of image pixels with one or more photoreceptors of the eye based on the photoreceptor map;
modify the image pixel to produce a retinal-corrected digital image, where the image pixel is modified based on a light sensitivity of the one or more photoreceptors associated with the image pixel; and
display the retinal-corrected digital image to a user via the near-eye display.

16. The virtual reality computing device of claim 15, where:
the near-eye display includes a plurality of display pixels;
each image pixel of the plurality of image pixels is shown at a different display pixel of the near-eye display;
the photoreceptor map indicates, for each display pixel, one or more photoreceptors that receive light originating from that display pixel; and
associating the image pixel with one or more photoreceptors includes determining at which display pixel the image pixel will be shown, and identifying, via the photoreceptor map, the one or more photoreceptors that receive light originating from that display pixel.

17. The virtual reality computing device of claim 16, where the instructions are further executable to track a gaze vector of the eye and, as the gaze vector changes, dynamically update the photoreceptor map for each display pixel to indicate one or more photoreceptors that receive light from that display pixel based on a current gaze vector of the eye.

18. The virtual reality computing device of claim 15, where the photoreceptor map indicates a color sensitivity for each photoreceptor in the distribution of photoreceptors, and modifying the image pixel includes increasing a specific color intensity of a specific color of the image pixel if the image pixel is associated primarily with cone photoreceptors poorly insensitive to the specific color.

19. The virtual reality computing device of claim 15, where the photoreceptor map is generated using a machine learning classifier that identifies rod and cone photoreceptors in the eye based on the retinal scan.

20. A virtual reality computing device, comprising:
a near-eye display including a plurality of display pixels;
a retinal scanner;
a logic machine; and
a storage machine holding instructions executable by the logic machine to:
perform a retinal scan of an eye with the retinal scanner;
based on the retinal scan, generate a photoreceptor map indicating a distribution of photoreceptors in the eye, a light sensitivity and a color sensitivity for each photoreceptor in the distribution, and for each display pixel of the near-eye display, one or more photoreceptors that receive light originating from that display pixel;
receive a digital image including a plurality of image pixels;
for an image pixel of the plurality of image pixels, identify a particular display pixel at which the image pixel will be shown;
associate the image pixel with one or more photoreceptors that receive light originating from the particular display pixel;
modify the image pixel to produce a retinal-corrected digital image, where the image pixel is modified based on the light sensitivity and the color sensitivity of the one or more photoreceptors associated with the image pixel; and
display the retinal-corrected digital image to a user via the near-eye display.
